(19) United States
(12) Patent Application Publication
(10) Pub. No.: US 2021/0133810 A1
(43) Pub. Date: May 6, 2021

(54) BILLBOARD INTERFACES FOR VEHICLE DISPLAYS

(71) Applicant: Ford Motor Company, Dearborn, MI (US)

(72) Inventors: Perry Robinson MACNEILLE, Lathrup Village, MI (US); Bo WU, Northville, MI (US)

(21) Appl. No.: 16/472,483

(22) PCT Filed: Dec. 21, 2016
(86) PCT No.: PCT/US2016/068131

§ 371 Date: Jun. 21, 2019

(51) Int. Cl. G06Q 30/02; G06K 9/00; G06F 40/134; H04W 4/40

(52) U.S. Cl. CPC G06Q 30/0265; G06K 9/00791; G06F 3/0488; H04W 4/40; G06F 40/134

(57) ABSTRACT

Method and apparatus are disclosed for billboard interface for display of vehicle. An example method for generating a billboard interface for a vehicle display includes obtaining, via a camera, an image of a billboard and identifying, via a processor, a segment of the image. The example method also includes determining an event associated with the segment and generating a billboard interface to include a hyperlink of the segment that initiates the event. The example method also includes communicating, via a communication module, the billboard interface to a vehicle display for presentation to a user.

### TECHNICAL FIELD

The present disclosure generally relates to billboards and, more specifically, billboard interface for display of vehicle.

### BACKGROUND

Oftentimes, billboards are located along roads to present information to drivers and/or passengers of vehicles traveling along the roads. In some examples, a billboard includes an advertisement for a business located nearby. The advertisement may include information related to the business, such as products and/or services provided by the business, an address and/or directions to a nearby location of the business, a phone number associated with the business, etc.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for billboard interface for display of vehicle. An example disclosed method for generating a billboard interface for a vehicle display includes obtaining, via a camera, an image of a billboard and identifying, via a processor, a segment of the image. The example disclosed method also includes determining an event associated with the segment and generating a billboard interface to include a hyperlink of the segment that initiates the event. The example disclosed method also includes communicating, via a communication module, the billboard interface to a vehicle display for presentation to a user.

An example disclosed system for presenting a billboard interface includes a mobile device to obtain, via a camera, an image of a billboard and identify, via a processor, a segment of the image. The mobile device also is to determine an event associated with the segment and generate a billboard interface to include a hyperlink of the segment that initiates the event. The example disclosed system also includes a vehicle to receive the billboard interface from the mobile device and present, via a display, the billboard interface.

An example disclosed tangible computer readable medium includes instructions which, when executed, cause a machine to obtain, via a camera, an image of a billboard and identify, via a processor, a segment of the image. The instructions, when executed, also cause the machine to determine an event associated with the segment, generate a billboard interface to include a hyperlink of the segment that initiates the event, and communicate the billboard interface to a vehicle display for presentation to a user.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example vehicle and an example mobile device in accordance with the teachings herein.

FIG. 2 illustrates an image of a billboard obtained via the mobile device of FIG. 1.

FIG. 3 illustrates a billboard interface that is generated to be presented via a display of the vehicle of FIG. 1.

FIG. 4 is a block diagram of electronic components of the mobile device of FIG. 1.

FIG. 5 is a block diagram of electronic components of the vehicle of FIG. 1.

FIG. 6 is a flowchart of an example method to generate the billboard interface of FIG. 3 to be presented via a display of the vehicle of FIG. 1.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Billboards oftentimes are located near (e.g., adjacent to, along a side of, overhanging) a road to provide information to drivers and/or passengers of passing vehicles. For example, a billboard may include an advertisement for a nearby business. In such instances, the advertisement includes information related to the business. For example, the information provided by the advertisement may include information that attracts the drivers and/or passengers to the business (e.g., available products and/or services). Additionally, the information of the billboard may include information that directs the drivers and/or passengers of the vehicles to the business (e.g., an address of a nearby location, directions to the nearby location, a phone number of the business).

The driver and/or passenger of the vehicle has a limited amount of time to obtain information from the billboard located near the road as the vehicle approaches and passes the billboard. In some instances, the driver and/or passenger of the vehicle may miss information of the advertisement on the billboard that directs the driver and/or passenger to the corresponding business. For example, while the driver may be able to identify an advertised product and/or service and determine whether the advertised product and/or service is of interest, the driver may be unable to identify the address of and/or directions to the location of the corresponding business before the vehicle passes the billboard. In other instances, the driver may able to identify the address and/or the directions of the advertisement but unable to write the address and/or the directions down to facilitate driving to the business location. In such instances, the driver is unable to locate the business that is advertised via the billboard.

Examples disclosed herein generate a billboard interface that is presented via a vehicle display to facilitate a user (e.g., a driver, a passenger) of a vehicle to obtain information related to a nearby billboard advertisement. The billboard interface includes a hyperlink of a segment of the billboard advertisement that initiates an event corresponding to the segment of the billboard advertisement to enable the user to obtain additional information associated with the billboard advertisement before, during, and/or after the vehicle passes the billboard advertisement. For example, the user may select a segment of the billboard interface that includes a phone number included in the billboard advertisement. Upon selecting the segment with the phone number, the vehicle and/or a mobile device of the user calls the phone number, for example, to enable the user to place an order with a business associated with the billboard advertisement.

Example systems disclosed herein include a mobile device and a vehicle of a user (e.g., a driver, a passenger). The user and the mobile device of the user are located within an interior of the vehicle as the vehicle travels along a road.

The mobile device includes a camera that obtains an image of a billboard located near a road along which the vehicle is traveling. The mobile device is positioned within the vehicle so that the camera is able to obtain the image of the billboard as the vehicle approaches the billboard. Further, the mobile device includes a billboard segmenter and a communication module (e.g., a first communication module). The billboard segmenter identifies a segment of the image, determines an event associated with the segments, and generates a billboard interface to include a hyperlink of the segment that initiates the event. The communication module of the mobile device sends the billboard interface to the vehicle to be presented to the user. In some examples, the billboard segmenter includes an image recognition system that identifies the segment of the image of the billboard via a deep neural network. Also, in some examples, the mobile device includes another communication module (e.g., a second communication module) in communication with a database that includes segment entries and corresponding event entries. In such examples, the billboard segmenter determines the event associated with the segment by matching the segment of the image of the billboard to one of the segment entries of the database and identifies the corresponding one of the event entries of the database.

The vehicle includes a communication module (e.g., a third communication module) that communicatively couples to and receives the billboard interface from the communication module (e.g., the first communication module) of the mobile device. The vehicle also includes a display to present the billboard interface to the user. Further, the vehicle includes a billboard linker that detects when the user selects the segment of the billboard interface and subsequently initiates the corresponding event via the hyperlink. In some examples, the display is a touch screen. In such examples, the billboard linker detects a selection of the segment of the billboard interface when the user presses a portion of the touch screen corresponding to the segment of the billboard interface. Additionally, or alternatively, the vehicle includes a microphone to receive audible instructions from the user to select the segment of the billboard interface presented via the display.

In the examples disclosed herein, the segment of the billboard interface that is presented via the display of the vehicle include a logo, a product, a phone number, an address, directions and/or any other portion of the advertisement of the billboard. In some examples, the segment of the billboard interface includes an address of a business associated with the advertisement of the billboard. In some such examples, the display presents visual directions to the address upon the user selecting the segment of the billboard interface. Additionally, or alternatively, the vehicle includes speakers that present audible instructions to the address upon the user selecting the segment. In other examples, the event initiated by the selection of the segment of the billboard interface is a phone call to a phone number of the business associated with the advertisement of the billboard.

In some examples, the billboard segmenter of the mobile device identifies a first segment of the image and a second segment different than the first image. In such examples, the billboard segmenter determines a first event associated with the first segment and a second event that is associated with the second segment and different than the first event. Further, in such examples, the billboard generates the billboard interface to include a first hyperlink of the first segment that initiates the first event and a second hyperlink of the second segment that initiates the second event. For example, the first event is a phone call to a phone number of a business associated with the advertisement of the billboard, and the second event is a presentation of directions to an address of the business.

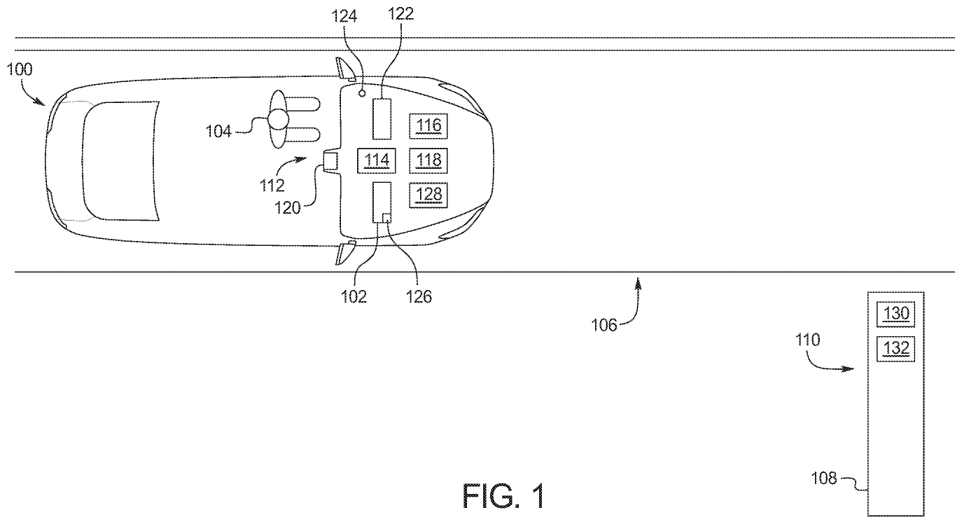

Turning to the figures, FIG. 1 illustrates an example vehicle 100 and an example mobile device 102 (e.g., a smart phone, a dashboard camera, a tablet, a smart watch, a wearable) of a user 104 (e.g., a driver, a passenger) in accordance with the teachings herein. The vehicle 100 may be a standard gasoline powered vehicle, a hybrid vehicle, an electric vehicle, a fuel cell vehicle, and/or any other mobility implementation type of vehicle. The vehicle 100 includes parts related to mobility, such as a powertrain with an engine, a transmission, a suspension, a driveshaft, and/or wheels, etc. The vehicle 100 may be non-autonomous, semi-autonomous (e.g., some routine motive functions controlled by the vehicle 100), or autonomous (e.g., motive functions are controlled by the vehicle 100 without direct driver input). As illustrated in FIG. 1, the vehicle 100 is traveling along a road 106 in a direction toward a billboard 108 that is positioned adjacent to the road 106. The billboard 108 includes an advertisement 110 and/or other information that is intended to be viewed by the user 104 as the vehicle 100 approaches and/or passes the billboard 108. In the illustrated example, the vehicle 100 includes an infotainment head unit 112, a communication module 114, a global positioning sensor (GPS) receiver 116, and a camera 118.

The infotainment head unit 112 provides an interface between the vehicle 100 and the user 104. The infotainment head unit 112 includes digital and/or analog interfaces (e.g., input devices and output devices) to receive input from and display information for the user(s). The input devices include, for example, a control knob, an instrument panel, a digital camera for image capture and/or visual command recognition, a touch screen, an audio input device (e.g., cabin microphone), buttons, or a touchpad. The output devices may include instrument cluster outputs (e.g., dials, lighting devices), actuators, a heads-up display, a center console display (e.g., a liquid crystal display (LCD), an organic light emitting diode (OLED) display, a flat panel display, a solid state display, etc.), and/or speakers. In the illustrated example, the infotainment head unit 112 includes hardware (e.g., a processor or controller, memory, storage, etc.) and software (e.g., an operating system, etc.) for an infotainment system (such as SYNC®, MyFord Touch®, SmartDeviceLink®, and AppLink® by Ford®; Entune® by Toyota®; IntelliLink® by GMC®; etc.). Additionally, the infotainment head unit 112 displays the infotainment system on, for example, the center console display.

As illustrated in FIG. 1, the infotainment head unit 112 includes a display 120 and a speaker 122. Additionally, a microphone 124 in and/or near the infotainment head unit 112. The display 120 presents an interface (e.g., a billboard interface 300 of FIG. 3) to provide information to the user 104. In the illustrated example, the display 120 is a touch screen that enables the user 104 to select button(s), hyperlink(s), etc. to provide additional information to the user 104. Further, the speaker 122 provides audio output information to the user 104, and the microphone 124 receives audio input information (e.g., instructions for the infotainment head unit 112) from the user 104.

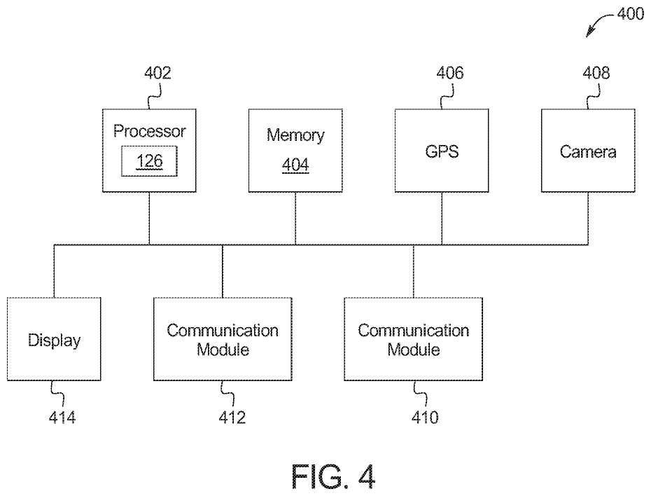

The communication module 114 of the vehicle 100 is to communicatively couple to the mobile device 102. For example, the communication module 114 communicatively couples to a communication module (e.g., a communication module 412 of FIG. 4) of the mobile device 102. In the illustrated example, the communication module 114 is a short-range wireless module that includes a wireless transducer to wirelessly communicate with the mobile device 102 and/or another device when that device is within a broadcast range of the communication module 114. The short-range wireless module includes hardware and firmware to establish a connection with the mobile device 102. In some examples, the short-range wireless module implements the Bluetooth and/or Bluetooth Low Energy (BLE) protocols. The Bluetooth and BLE protocols are set forth in Volume 6 of the Bluetooth Specification 4.0 (and subsequent revisions) maintained by the Bluetooth Special Interest Group.

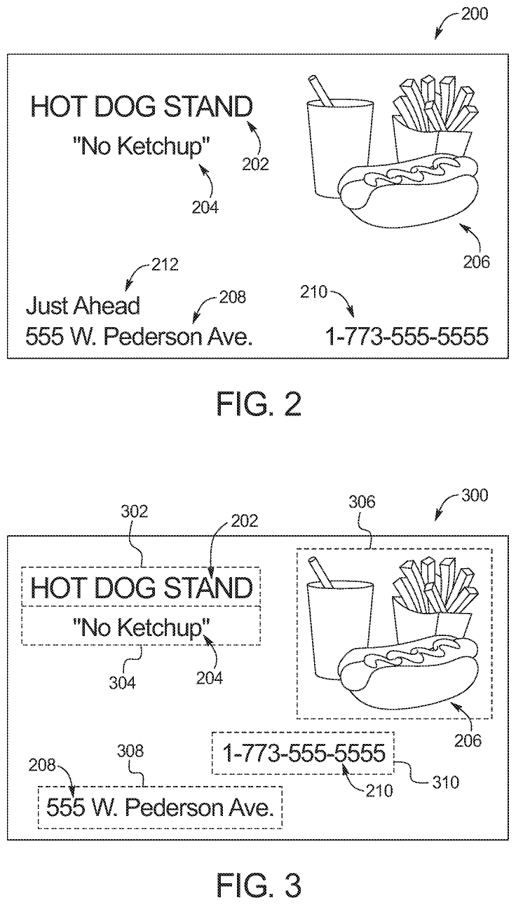

Additionally, the GPS receiver 116 identifies a location of the vehicle 100. For example, the GPS receiver 116 is utilized to track the location of the vehicle 100 as the vehicle 100 travels along a set of directions from one location to another location. Further, the camera 118 of the vehicle 100 is utilized to collect, receive and/or otherwise obtain image(s) of object(s) that are adjacent to an exterior of the vehicle 100. For example, the camera 118 may be utilized to obtain an image (e.g., an image 200 of FIG. 2) of the advertisement 110 of the billboard 108.

As illustrated in FIG. 1, the mobile device 102 of the user 104 is located within an interior of the vehicle 100 as the user 104 drives the vehicle 100 toward the billboard 108. The mobile device 102 is communicatively coupled to the communication module 114 of the vehicle 100 and includes a billboard segmenter 126 that enables the display 120 of the vehicle 100 to present a billboard interface to the user 104.

In operation, the mobile device 102 collects, receives and/or otherwise obtains an image of the advertisement 110 of the billboard 108. For example, the mobile device 102 includes a camera (e.g., a camera 408 of FIG. 4) to obtain the image of the billboard 108. The billboard segmenter 126 identifies one or more segments of the image. For example, the billboard segmenter 126 includes an image recognition system that identifies the one or more segments utilizing a deep neural network algorithm. The billboard segmenter 126 determines whether the identified segment(s) are associated with events that correspond to the advertisement 110 of the billboard 108. Further, the billboard segmenter 126 generates a billboard interface to be presented to the user 104 based on the image of the advertisement 110 of the billboard 108. The billboard interface generated by the billboard segmenter 126 includes hyperlinks that link the events to the corresponding segments. Upon generating the billboard interface, the mobile device 102 sends the billboard interface to the communication module 114 of the vehicle 100.

The display 120 of the vehicle 100 presents the billboard interface that is received from the mobile device 102 to the user 104. Further, the vehicle 100 includes a billboard linker 128 that detects when the user 104 selects a segment of the billboard interface. In examples in which the display 120 is a touch screen, the billboard linker 128 detects selection of a segment of the billboard interface when the user 104 presses a portion of the display 120 that corresponds to the segment. Additionally, or alternatively, the billboard linker 128 detects selection of a segment via audible instructions of the user 104 that are received via the microphone 124 of the vehicle 100. Upon detecting selection of a segment of the billboard interface, the billboard linker 128 initiates the corresponding event via the corresponding hyperlink. For example, in response to the user 104 selecting a segment associated with an address to a store location, the display 120 presents visual directions and/or the speaker 122 of the vehicle provides audible directions to the address.

Further, in the illustrated example, the billboard 108 is an electronic billboard that presents advertisements via an electronic display. As illustrated in FIG. 1, the billboard 108 includes a billboard processor 130 that controls which image is presented on the billboard 108. The billboard 108 also includes a communication module 132 that is communicatively coupled to the billboard processor 130. In operation, the billboard processor 130 may facilitate the billboard 108 in selecting and/or personalizing advertisements to be presented based on preferences and/or characteristics of users approaching the billboard 108. As the vehicle 100 approaches the billboard 108, the communication module 114 of the vehicle 100 and/or a communication module (e.g., the communication module 410) of the mobile device 102 communicatively couples to the billboard processor 130 via the communication module 132 of the billboard 108. For example, the communication module 132 receives information from the mobile device 102 and/or the vehicle 100 that are associated user preferences and/or characteristics of the user 104. The communication module 132 sends the user information to the billboard processor 130, and the billboard processor 130 selects and/or personalizes an advertisement (e.g., the advertisement 110) to display as the vehicle 100 approaches the vehicle based on the user information associated with the user 104.

In other examples, the camera 118 of the vehicle 100 may obtain or collect the image of the advertisement 110 as the vehicle 100 approaches the billboard 108. In some such examples, the vehicle 100 includes the billboard segmenter 126 that generates the billboard interface for the display 120 of the infotainment head unit 112. In other such examples, the billboard linker 128 identifies segment(s) of the advertisement 110, determines event(s) associated with the identified segment(s), and generates the billboard interface for the display 120. In other such examples, the camera 118 of the vehicle 100 sends, via the communication module 114, the image of the advertisement 110 to the mobile device 102 to enable the billboard segmenter 126 of the mobile device 102 to generate the billboard interface for the display 120 of the vehicle 100.

Additionally or alternatively, the mobile device 102 of the illustrated example may present the billboard interface to the user 104 via a display (e.g., a display 414 of FIG. 4) of the mobile device 102. The billboard interface may be presented to the user 104 via the display of the mobile device 102 when the user 104 remains within the vehicle 100, after the user 104 exits the vehicle 100, and/or as the user is walking near the billboard 108. For example, the camera of the mobile device 102 may obtain the image of the advertisement 110 and the display of the mobile device 102 may present the billboard interface as the user 104 walks along a side of the road 106 near the billboard 108. Further, when the user 104 is in a public transportation vehicle (e.g., a bus, a train, etc.), the camera of the mobile device 102 may obtain an image of an advertisement (e.g., located in the public transportation vehicle, located on a billboard next to the public transportation vehicle, etc.) and the display of the mobile device 102 may present the billboard interface to the user 104.

FIG. 2 illustrates an example image 200 of the advertisement 110 of the billboard 108 that is obtained via a camera (e.g., the camera 408 of FIG. 4) of the mobile device 102 and/or the camera 118 of the vehicle 100. In the illustrated example, the image 200 includes a first segment 202 (the “HOT DOG STAND” logo), a second segment 204 (the “No Ketchup” slogan), a third segment 206 (a product image of a hot dog, a drink, and fries), a fourth segment 208 (an address of “555 W. Pederson Ave”), a fifth segment 210 (a phone number of “1-773-555-5555”), and a sixth segment 212 (“Just Ahead” directions).

The billboard segmenter 126 of the mobile device 102 includes an image recognition system that identifies one or more of the segments 202, 204, 206, 208, 210, 212 of the image 200. For example, the image recognition system identifies one or more of the segments 202, 204, 206, 208, 210, 212 of the image 200 via a deep neural network algorithm. In some examples, the image recognition system identifies one or more of the segments 202, 204, 206, 208, 210, 212 by identifying corresponding boundaries and features within the corresponding boundaries. The billboard segmenter 126 compares the features within the identified boundaries to segment entries of a database. Further, the database also includes event entries that correspond to the segment entries. When the billboard segmenter 126 matches a feature within a boundary of the image 200 with a segment entry of the database, the billboard segmenter 126 associates the segment of the image 200 with the corresponding event entry of the database. For example, the image recognition system identifies a boundary around the first segment 202, identifies a feature within the boundary (the “HOT DOG STAND” logo), compares the feature to the segment entries of the database, matches the boundary to one of the segment entries (a “HOT DOG STAND” entry), and associates the first segment 202 to a corresponding event entry (e.g., access a “HOT DOG STAND” website) of the database. Based on one or more of the segments 202, 204, 206, 208, 210, 212 of the image 200 of the advertisement 110 of the billboard 108, the billboard segmenter 126 generates a billboard interface.

FIG. 3 illustrates an example billboard interface 300 that is generated by the billboard segmenter 126. The billboard interface 300 is presented via the display 120 of the vehicle 100 to enable the user 104 of the vehicle 100 to obtain, utilize, navigate and/or interact with information associated with advertisement 110.

The billboard interface 300 of the illustrated example is based on the image 200 of the billboard 108. For example, the billboard interface 300 includes the first segment 202 (the “HOT DOG STAND” logo) defined by a boundary 302, the second segment 204 (the “No Ketchup” slogan) defined by a boundary 304, the third segment 206 (a product image of a hot dog, a drink, and fries) defined by a boundary 306, the fourth segment 208 (an address of “555 W. Pederson Ave”) defined by a boundary 308 , and the fifth segment 210 (a phone number of “1-773-555-5555”) defined by a boundary 310. Each of the boundaries 302, 304, 306, 308, 310 of the billboard interface 300 defines a corresponding hyperlink that initiates a corresponding event. For example, the hyperlink defined by the boundary 302 opens a website of “HOT DOG STAND,” the hyperlink defined by the boundary 304 opens a social media page of “HOT DOG STAND,” the hyperlink defined by the boundary 306 opens a food-ordering app to place an order with “HOT DOG STAND,” the hyperlink defined by the boundary 308 prompts directions to be provided for a location of “HOT DOG STAND,” and the hyperlink defined by the boundary 310 initiates a phone call to a phone number of the location of “HOT DOG STAND.”

In the illustrated example, the billboard interface 300 has a different aspect ratio than that of the image 200 of the advertisement 110 of the billboard 108. For example, the aspect ratio of the billboard interface 300 may be defined to accommodate the dimensions of the display 120 of the vehicle 100. As illustrated in FIGS. 2 and 3, one or more of the segments 202, 204, 206, 208, 210 may be shifted and/or rearranged in the billboard interface 300 relative to their position in the image 200 to enable the segments 202, 204, 206, 208, 210 to fit within the aspect ratio of the billboard interface 300.

Further, in the illustrated example, each of the segments 202, 204, 206, 208, 210 of the billboard interface 300 are identical or substantially similar to the segments 202, 204, 206, 208, 210 of image 200 of the advertisement 110 of the billboard 108. In other examples, the billboard interface may include segments that are visually different, but correspond to, segments of the image 200.

Additionally, as illustrated in FIG. 3, the billboard interface 300 of the illustrated example does not include a segment that corresponds to the sixth segment 212 of the image 200. For example, the database may not include a segment entry that matches the sixth segment 212 and, thus, the billboard interface 300 generated by the billboard segmenter 126 does not include a corresponding segment.

FIG. 4 is a block diagram of electronic components 400 of the mobile device 102. As illustrated in FIG. 4, the electronic components 400 include a microcontroller unit, controller, or processor 402. Further, the electronic components include memory 404, a GPS receiver 406, a camera 408, a communication module 410, another communication module 412, and a display 414.

In the illustrated example, the processor 402 of the mobile device 102 is structured to include the billboard segmenter 126. The processor 402 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs).

The memory 404 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, the memory 404 includes multiple kinds of memory, particularly volatile memory and non-volatile memory.

The memory 404 is computer readable media on which one or more sets of instructions, such as the software for operating the methods of the present disclosure, can be embedded. The instructions may embody one or more of the methods or logic as described herein. For example, the memory 404 includes computer readable memory on which instructions for the application for accessing digital keys are embedded. The instructions may reside completely, or at least partially, within any one or more of the memory 404, the computer readable medium, and/or within the processor 402 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The GPS receiver 406 of the electronic components 400 identifies a location of the mobile device 102. For example, the GPS receiver 406 is utilized to track the location of the mobile device 102 as the mobile device 102 travels from one location to another location. In instances in which the mobile device 102 is located within the interior of the vehicle 100, the GPS receiver 406 may be utilized to track the location of the vehicle 100 as the vehicle 100 travels along a set of directions from one location to another location. Additionally, or alternatively, the GPS receiver 116 of the vehicle 100 may be utilized to track the location of the vehicle 100 as the vehicle 100 travels along the set of directions.

Further, the camera 408 of the vehicle 100 is utilized to collect, receive and/or otherwise obtain the image 200 of the advertisement 110 of the billboard 108 as the vehicle 100 approaches the billboard 108. The mobile device 102 is positioned by the user 104 within the interior of the vehicle 100 such that the camera 408 is able to obtain the image 200 of the advertisement 110. For example, the user 104 may couple the mobile device 102 to an interior surface of a windshield of the vehicle 100 or may lie the mobile device 102 on a dash of the vehicle 100 to enable the camera 408 of the mobile device 102 to obtain the image 200 of the billboard 108.

The communication module 410 is communicatively coupled to a network (e.g., the Internet) that includes a database. For example, the database includes the segment entries associated with segments of billboard advertisements and events entries that correspond to the segment entries. The database of segment entries and corresponding event entries may be created and/or curated by an entity such as an advertising entity that operates billboards and/or other entities that utilize the billboards for advertising. The communication module 410 enables the billboard segmenter 126 to access the database to identify events associated with one or more of the segments 202, 204, 206, 208, 210, 212 of the image 200 of the advertisement 110 of the billboard 108. In some examples, the database is indexed by GPS location of billboards to facilitate identification of the segment entries and/or to avoid the inclusion of duplicative segment entries. In some examples, updates to the database may be instantly or automatically sent to the billboard segmenter 126 via the communication module 410 so that the billboard segmenter 126 is able to update the billboard interface 300. For example, a restaurant may remove a segment entry associated with a coupon for the restaurant when the restaurant is full, and the billboard segmenter 126 may subsequently automatically remove the segment associated with the coupon from the billboard interface 300. Further, in some examples, the communication module 410 also communicatively couples to the communication module 132 of the billboard 108 to enable the billboard processor 130 to select and/or personalize advertisements for the user 104 as the vehicle 100 approaches the billboard 108.

The communication module 412 of the mobile device 102 is to communicatively couple to the communication module 114 of the vehicle 100. In the illustrated example, the communication module 412 is a short-range wireless module that includes a wireless transducer to wirelessly communicate with the vehicle 100 and/or another device when that device is within a broadcast range of the communication module 412. The short-range wireless module includes hardware and firmware to establish a connection with the communication module 114 of the vehicle 100. In some examples, the short-range wireless module implements the Bluetooth and/or Bluetooth Low Energy (BLE) protocols.

The display 414 presents an interface to provide information to the user 104 via the mobile device 102. For example, the display 414 may present the billboard interface 300 to the user 104. In some such examples, the display 414 is a touch screen that enables the user 104 to select one or more of the hyperlinks of the billboard interface 300.

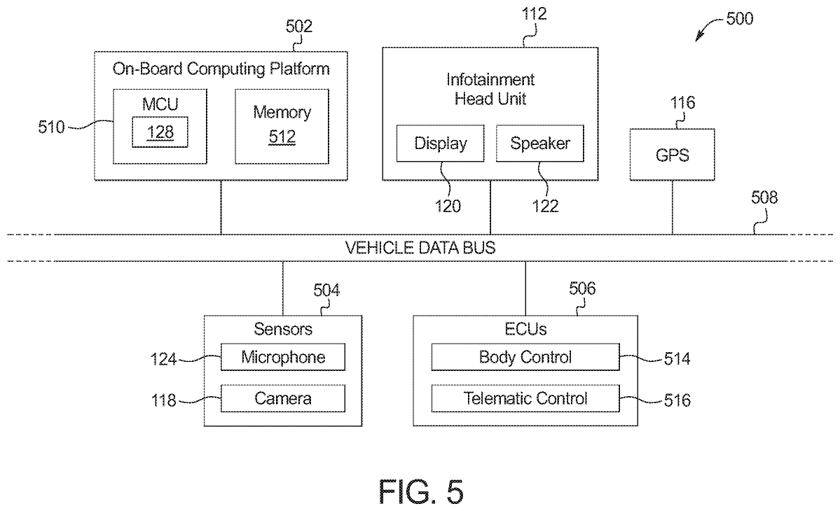

FIG. 5 is a block diagram of electronic components 500 of the vehicle 100. As illustrated in FIG. 5, the electronic components 500 include an on-board computing platform 502, the infotainment head unit 112 that includes the display 120 and the speaker 122, the GPS receiver 116, sensors 504, electronic control units (ECUs) 506, and a vehicle data bus 508.

The on-board computing platform 502 includes a microcontroller unit, controller or processor 510 and memory 512. In some examples, the on-board computing platform 502 is structured to include billboard linker 128. Alternatively, in some examples, the billboard linker 128 is incorporated into another electronic control unit (ECU) with its own processor 510 and memory 512. Further, in some examples, the billboard linker 128 may be incorporated into the processor 402 of the mobile device 102 that communicates with the on-board computing platform 502 via the communication module 412 of the mobile device 102 and the communication module 114 of the vehicle 100. The processor 510 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 512 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc). In some examples, the memory 512 includes multiple kinds of memory, particularly volatile memory and non-volatile memory.

The memory 512 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 512, the computer readable medium, and/or within the processor 510 during execution of the instructions.

The sensors 504 are arranged in and around the vehicle 100 to monitor properties of the vehicle 100 and/or an environment in which the vehicle 100 is located. One or more of the sensors 504 may be mounted to measure properties around an exterior of the vehicle 100. Additionally or alternatively, one or more of the sensors 504 may be mounted inside a cabin of the vehicle 100 or in a body of the vehicle 100 (e.g., an engine compartment, wheel wells, etc.) to measure properties in an interior of the vehicle 100. For example, the sensors 504 include accelerometers, odometers, tachometers, pitch and yaw sensors, wheel speed sensors, microphones, tire pressure sensors, biometric sensors and/or sensors of any other suitable type. In the illustrated example, the sensors 504 include the microphone 124 and the camera 118.

The ECUs 506 monitor and control the subsystems of the vehicle 100. For example, the ECUs 506 are discrete sets of electronics that include their own circuit(s) (e.g., integrated circuits, microprocessors, memory, storage, etc.) and firmware, sensors, actuators, and/or mounting hardware. The ECUs 506 communicate and exchange information via a vehicle data bus (e.g., the vehicle data bus 508). Additionally, the ECUs 506 may communicate properties (e.g., status of the ECUs 506, sensor readings, control state, error and diagnostic codes, etc.) to and/or receive requests from each other. For example, the vehicle 100 may have seventy or more of the ECUs 506 that are positioned in various locations around the vehicle 100 and are communicatively coupled by the vehicle data bus 508. In the illustrated example, the ECUs 506 include a body control module 514 and a telematic control unit 516. The body control module 514 controls one or more subsystems throughout the vehicle 100, such as power windows, power locks, an immobilizer system, power mirrors, etc. For example, the body control module 514 includes circuits that drive one or more of relays (e.g., to control wiper fluid, etc.), brushed direct current (DC) motors (e.g., to control power seats, power locks, power windows, wipers, etc.), stepper motors, LEDs, etc. The telematic control unit 516 controls tracking of the vehicle 100, for example, utilizing data received by the GPS receiver 116 of the vehicle 100.

The vehicle data bus 508 communicatively couples the on-board computing platform 502, the infotainment head unit 112, the GPS receiver 116, the sensors 504, and the ECUs 506. In some examples, the vehicle data bus 508 includes one or more data buses. The vehicle data bus 508 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

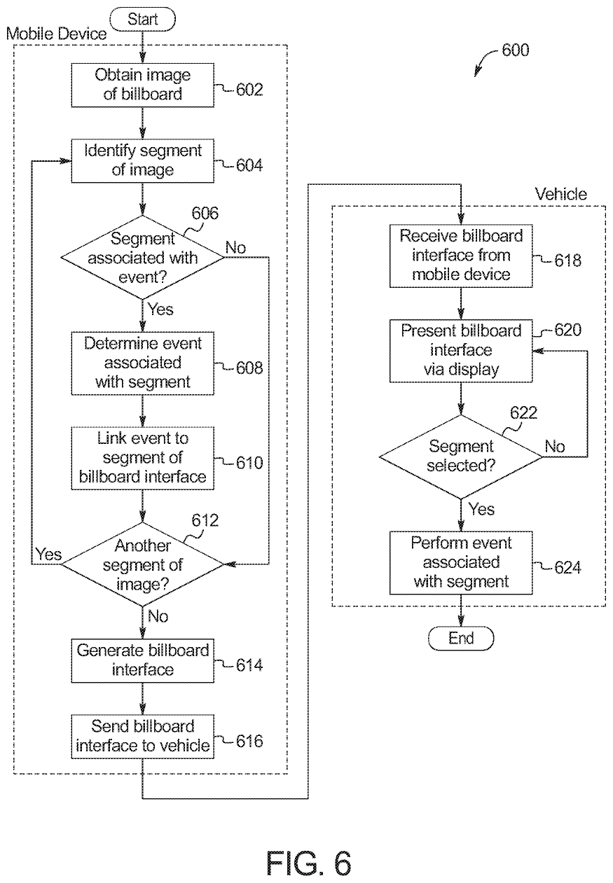

FIG. 6 is a flowchart of an example method 600 to generate a billboard interface to be presented via a display of a vehicle. The flowchart of FIG. 6 is representative of machine readable instructions that are stored in memory (such as the memory 404 of FIG. 4 and/or the memory 512 of FIG. 5) and include one or more programs which, when executed by a processor (such as the processor 402 of FIG. 4 and/or the processor 510 of FIG. 5), cause the vehicle 100 and/or the mobile device 102 to implement the example billboard linker 128 of FIGS. 1 and 5 and/or the example billboard segmenter 126 of FIGS. 1 and 4. While the example program(s) is/are described with reference to the flowchart illustrated in FIG. 6, many other methods of implementing the example billboard segmenter 126 and/or the example billboard linker 128 may alternatively be used. For example, the order of execution of the blocks may be rearranged, changed, eliminated, and/or combined to perform the method 600. Further, because the method 600 is disclosed in connection with the components of FIGS. 1-5, some functions of those components will not be described in detail below.

Initially, at block 602, the camera 408 of the mobile device 102 obtains the image 200 of the advertisement 110 of the billboard 108. At block 604, the billboard segmenter 126 identifies a segment of the image 200. For example, the billboard segmenter 126 includes an image recognition system that identifies the first segment 202 of the segments 202, 204, 206, 208, 210, 212 utilizing a deep neural network algorithm.

At block 606, the billboard segmenter 126 determines whether the segment of the image 200 is associated with an event. For example, the billboard segmenter 126 compares the segment of the image 200 to segment entries of a database that also includes corresponding event entries. If the segment of the image 200 matches one of the segment entries of the database, the billboard segmenter 126 determines that an event is associated with the segment of the image 200 and proceeds to block 608 at which the billboard segmenter 126 determines the event entry of the database that corresponds to the segment of the image 200. For example, the billboard segmenter 126 determines that the first segment 202 corresponds with accessing a website. Further, at block 610, the billboard segmenter 126 links the event (e.g., accessing the website) to the segment.

Upon determining that the segment is not associated with an event at block 606 or upon linking the event to the segment at block 610, the billboard segmenter 126 determines whether there is another of the segments 202, 204, 206, 208, 210, 212 of the image 200 (block 612). If the billboard segmenter 126 determines that there is another segment, the method 600 repeats blocks 604, 606, 608, 610, 612 until no other segment of the image 200 is identified.

Upon completing block 612, the billboard segmenter 126 generates the billboard interface 300 (block 614). For example, the billboard segmenter 126 generates the billboard interface 300 to include the segments 202, 204, 206, 208, 210 and the corresponding hyperlinks to initiate the corresponding events. At block 616, the communication module 410 of the mobile device 102 sends the billboard interface 300 to the communication module 114 of the vehicle 100.

At block 618, the communication module 114 of the vehicle 100 receives the billboard interface 300 from the communication module 410 of the mobile device 102. At block 620, the display 120 of the vehicle 100 presents the billboard interface 300 for the user 104. At block 622, the billboard linker 128 of the vehicle 100 determines whether a segment of the billboard interface 300 has been selected by the user 104. If the billboard linker 128 determines that a segment has not been selected, the method returns to block 620. Otherwise, if the billboard linker 128 determines that a segment has been selected, the method 600 proceeds to block 624 at which the billboard linker 128 performs the event associated with the selected segment. For example, if the billboard linker 128 determines that the user 104 has selected the first segment 202 (block 622), the billboard linker 128 presents the website to the user 104 via the display 120. After block 624 is completed, the method 600 ends.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A method for generating billboard interfaces for vehicle displays, the method comprising:
obtaining, via a camera, an image of a billboard;
identifying, via a processor, a segment of the image;
determining an event associated with the segment;
generating a billboard interface to include a hyperlink of the segment that initiates the event; and
communicating, via a communication module, the billboard interface to a vehicle display for presentation to a user.

2. The method of claim 1, wherein the segment includes an address associated with the image of the billboard.

3. The method of claim 2, further including presenting visual directions to the address via the vehicle display upon selection of the segment.

4. The method of claim 2, further including presenting audible directions to the address upon selection of the segment.

5. The method of claim 1, wherein the vehicle display is a touch screen.

6. The method of claim 5, further including:
detecting a selection of the segment of the billboard interface via the touch screen; and
initiating the event via the hyperlink upon detecting the selection.

7. The method of claim 1, further including:
identifying a second segment of the image different than the segment;
determining a second event associated with the second segment, the second event different than the event; and
generating the billboard interface to further include a second hyperlink of the second segment that initiates the second event.

8. A system for presenting billboard interfaces, the system comprising:
a mobile device to:
obtain, via a camera, an image of a billboard;
identify, via a processor, a segment of the image;
determine an event associated with the segment; and
generate a billboard interface to include a hyperlink of the segment that initiates the event; and
a vehicle to:
receive the billboard interface from the mobile device; and
present, via a display, the billboard interface.

9. The system of claim 8, wherein the display of the vehicle is a touch screen configured to detect a selection of the segment of the billboard interface presented via the touch screen.

10. The system of claim 8, wherein the vehicle includes a microphone to receive audible instructions to select the segment of the billboard interface presented via the display.

11. The system of claim 8, wherein the vehicle initiates the event via the hyperlink upon the segment of the billboard interface being selected.

12. The system of claim 11, wherein the vehicle includes a billboard linker to detect selection of the segment and initiate the event via the hyperlink upon detecting the selection of the segment.

13. The system of claim 8, wherein the mobile device:
identifies a second segment of the image different than the segment;
determines a second event associated with the second segment, the second event different than the event; and
generates the billboard interface to further include a second hyperlink of the second segment that initiates the second event.

14. The system of claim 13, wherein the event is a phone call to a phone number associated with the image of the billboard and the second event is a presentation of directions to an address associated with the image of the billboard.

15. A tangible computer readable medium including instructions which, when executed, cause a machine to:
obtain, via a camera, an image of a billboard;
identify, via a processor, a segment of the image;
determine an event associated with the segment;
generate a billboard interface to include a hyperlink of the segment that initiates the event; and
communicate the billboard interface to a vehicle display for presentation to a user.

16. The tangible computer readable medium of claim 15, wherein, to identify the segment of the image, the instructions further cause the machine to utilize an image recognition system that identifies the segment via a deep neural network.

17. The tangible computer readable medium of claim 15, wherein the event is a phone call to a phone number associated with the image of the billboard.

18. The tangible computer readable medium of claim 15, wherein the instructions further cause the machine to communicate with a database that includes segment entries and corresponding event entries.

19. The tangible computer readable medium of claim 18, wherein, to determine the event associated with the segment, the instructions further cause the machine to match the segment to one of the segment entries of the database and identifying the corresponding one of the event entries.

20. The tangible computer readable medium of claim 18, wherein the instructions further cause the machine to communicate to a billboard processor to facilitate the billboard to display a personalized advertisement for a user.
